(19) United States
(12) Patent Application Publication
(10) Pub. No.: US 2005/0053281 A1
(43) Pub. Date: Mar. 10, 2005

(54) Method and apparatus for acquiring image characteristics

(75) Inventor: David A. Frazer, Irvine, CA (US)

Correspondence Address: CHARLES C.H. WU, 98 DISCOVERY, IRVINE, CA, 92618-3105, US

(73) Assignee: MATCH LAB, INC.

(21) Appl. No.: 10/656,610

(22) Filed: Sep. 6, 2003

(51) Int. Cl. G06K 9/00

(52) U.S. Cl. 382/168

(57) ABSTRACT

An apparatus and method for determining characteristics of an input image. The method includes the step of receiving a single pixel stream of the input image. Next, the method sub-samples data from the single pixel stream at programmable intervals. Finally, the method creates a histogram with characteristics of the input image based on the sub-sampled data. By determining characteristics of the input image, the method facilitates subsequent imaging processing functions.

### BACKGROUND OF THE INVENTION

1. Field of the Invention

The invention relates in general to image processing. More particularly, this invention relates to a method and apparatus for determining image characteristics during acquisition but before processing.

2. Description of the Related Art

The image processing that succeeds document acquisition in copier, facsimile or document processing applications depends largely upon or is greatly enhanced by some knowledge of the document characteristics. Whether a document is black and white or color, photo versus text, low in contrast or high in contrast, and dark or light dictates the methods best suited for processing of the image data for printing, storing or transmission. The ability to determine these and other characteristics is paramount to proper processing and duplication.

In U.S. Pat. No. 6,473,522, Lienhart discloses a method for receiving a digital image including text and background. The method includes vector quantizing the digital image such that the digital image is divided into certain colors, and creating a text color histogram from a portion of the text and a first portion of the background. The method also includes creating at least one background color histogram from a second portion of the background, and creating a difference color histogram from a difference between the text color histogram and the at least one background color histogram, and wherein an estimated color of the text is derived from the difference color histogram.

Unlike the subject invention, Lienhart does not perform sub-sampling on a pixel and line basis at programmable intervals. Instead, Lienhart uses a portion of the text and two portions of the background to create histograms.

### SUMMARY OF THE INVENTION

Accordingly, one object of the present invention is to provide an image processing device that acquires characteristics of an image, such as whether an image is black and white or color, low or high in contrast, photo or text, and dark or light.

A second object of the invention is to provide an image processing device that determines image characteristics during acquisition but before processing and duplication.

To achieve these and other advantages and in accordance with the purpose of the invention, as embodied and broadly described herein, the invention provides an apparatus and method for determining characteristics of an input image. The method includes the step of receiving a single pixel stream of the input image. Next, the method sub-samples data from the single pixel stream at programmable intervals. Finally, the method creates a histogram with characteristics of the input image based on the sub-sampled data. By determining characteristics of the input image, the method facilitates subsequent imaging processing functions.

### BRIEF DESCRIPTION OF THE DRAWINGS

FIG. 1 is a block diagram illustrating a simplified imaging system in which the present invention may be employed.

FIG. 2 is a block diagram illustrating a low-level imaging system in which the present invention may be employed.

FIG. 3 is a block diagram illustrating a controlling module and RAM table of the present invention.

FIG. 4 is a block diagram illustrating the major internal modules of the present invention.

FIG. 5 is a block diagram depicting the states within the controlling state machine that update histogram values in accordance with the present invention.

FIG. 6 is a graphical depiction of a sub-sample grid for the present invention.

### DESCRIPTION OF THE PREFERRED EMBODIMENTS

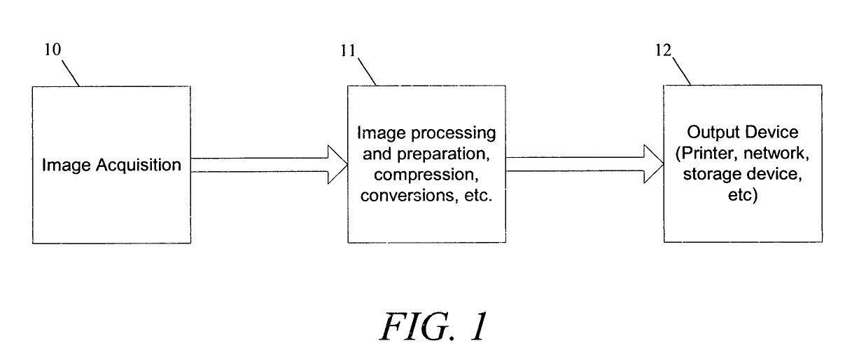

Referring now to FIG. 1, a block diagram illustrating a simplified imaging system in which the present invention may be employed is shown. The imaging system includes an image acquisition means 10 for capturing the image. The acquired image is then processed via an imaging processing means 11. In addition to processing the image, image processing means 11 performs any desired conversion, compression or enhancement of the acquired image. Finally, the imaging system provides for appropriate output to device 12 for storage, reproduction or transmission. Examples of output device 12 include a printer, a network or a storage device.

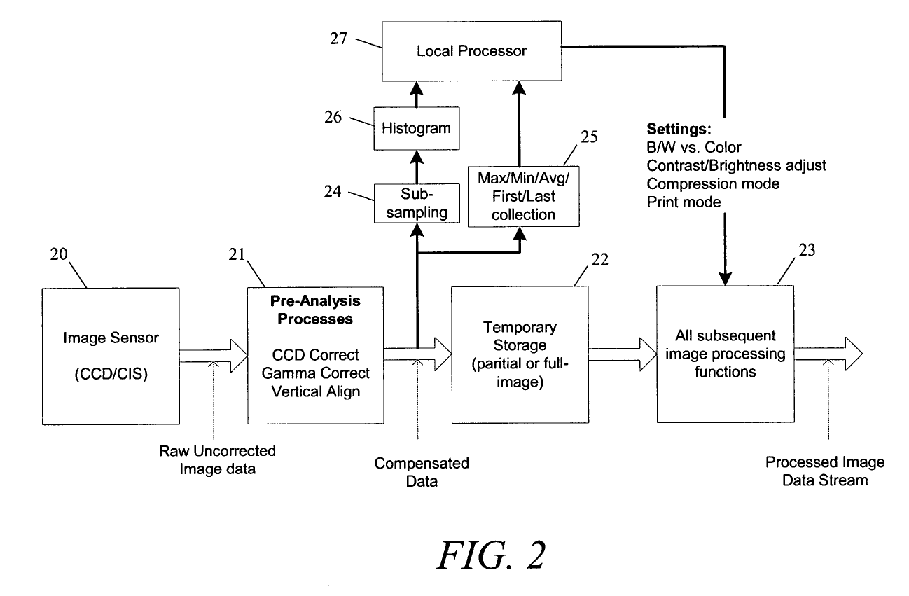

With reference to FIG. 2, a block diagram illustrating a low-level imaging system in which the present invention may be employed is shown. The imaging system includes an image sensor 20 for receiving input image data. One example of image sensor 20 is a CCD sensor (charge-coupled device). This is the type of sensor used in desktop scanners. Another example of image sensor 20 is a CIS sensor (contact image sensor), a newer technology that integrates scanning functions into fewer components, allowing scanners to be more compact in size. Other scanning technologies will suffice for input sensor 20. After being scanned by image sensor 20, the input image is in a raw an uncorrected form that must be compensated for.

Still referring to FIG. 2, the imaging system further includes a pre-analysis processes module 21. The pre-analysis module 21 processes image data pixel streams from image sensor 20 to create a single valid pixel stream that can be monitored by the present invention. Typically there exist functions that adjust the RGB values provided by the image sensor 20 to compensate for the sensitivity characteristics of the sensor. The RGB values may also be realigned vertically so that physical offsets between the colors are eliminated.

The functions that may be provided to adjust the RGB values include: 1) correction and compensation for the gain of the individual pixel sensors when an array of sensors is utilized; 2) elimination of the physical, line-separation of the three RGB color planes; 3) compensation for “dark currents” in the CCD device that affect the minimum black pixel values; 4) adjustment of the gain of the sensor so that white values yield a corresponding maximum pixel value of the R/G/B components; and 5) gamma correction for each of the color components to compensate for the different sensitivities of the sensors for different wavelengths of light.

The resulting output from the pre-analysis processes module 21 is a single pixel stream with line and page indicators, where the components of a pixel are available simultaneously. For example, if the RGB components are each represented by 8 bits, then the color stream would consist of a 24-bit bus with a valid pixel indicator, and on each indication would exist R, G and B components corresponding to the same physical pixel on the image being sensed. This is necessary so that the color of the pixel can be established and used as an index to the histogram table described below.

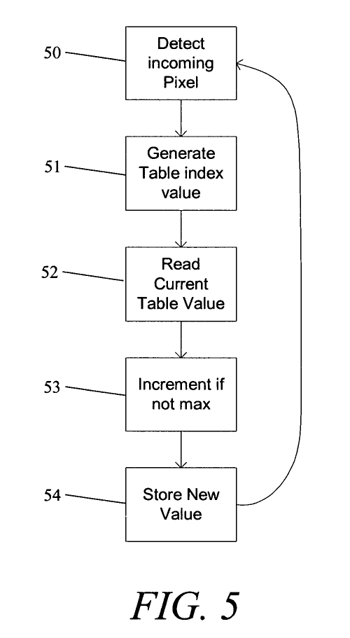

Still referring to FIG. 2, modules 24 thru 27 represent the present invention. Sub-sampling module 24 is used for sub-sampling image data for subsequent histogram analysis. Histogram module 26 uses the sub-sampled data to develop a histogram of the image data. This process is further described in FIG. 5. The histogram provides the basis for subsequent analysis by resident software or firmware. The present invention also utilizes a collection module 25 to obtain information regarding maximum and minimum, first and last, and average pixel values. The present invention also employs a local processor 27.

Prior to modules 24 thru 27, the image is scanned and pre-analysis processes are performed. As discussed above, these processes are typically independent of the document type and merely compensate and correct for the inadequacies or characteristics of the acquisition system. Processes occurring after modules 24 thru 27 are those that benefit from the invention.

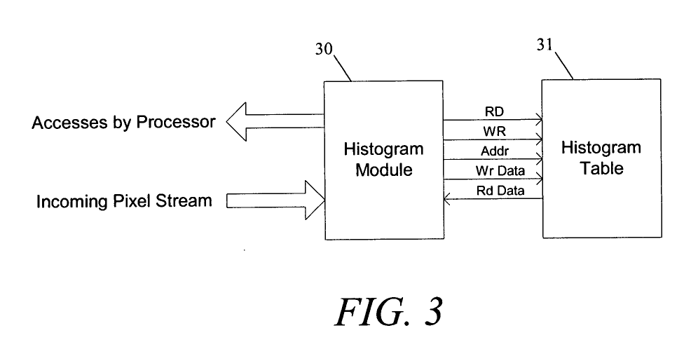

Referring now to FIG. 3, a block diagram illustrating a controlling module and RAM table of the present invention is shown. Based on the incoming image pixel data, controlling module 30, or histogram module, generates an index to histogram table 30.

Still referring to FIG. 3, incoming pixel data is truncated to a minimal number of bits in order to reduce the required depth of histogram table 31. For example, if the incoming pixel components are trimmed to 4 bits from 8, then a total of 12 bits of color value might be used as an index to histogram table 31. The color value is converted from RGB color space to a YCrCb color space so that both the intensity of the color and the color content can be more easily established, and so the contents of histogram table 31 are more readily interpreted by local processor 27.

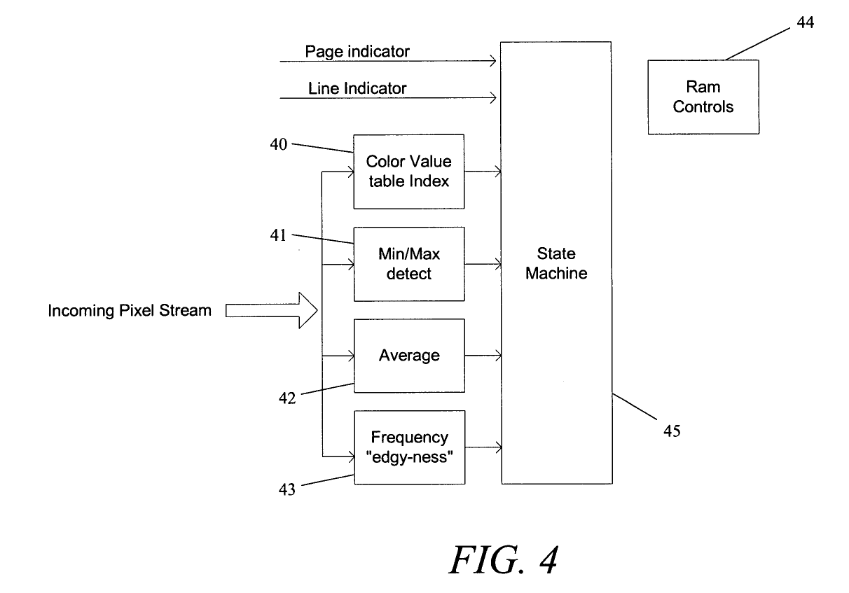

With reference to FIG. 4, a block diagram illustrating the major internal modules of the present invention is shown. State machine 45 generates indices used to access histogram table 31. In addition, color value table index module 40, minimum/maximum detection module 41, average module 42 and frequency edge module 43 monitor the pixel stream and can provide additional information, usually on a line basis.

Still referring to FIG. 4, sampling effects must be taken into account when creating an intensity and color map of the image. Since an input sensor 20 within a CCD device is independent and subject to sampling effects, a transition from black to white within an image may not produce a black pixel following by a white pixel when presented in the RGB format. Instead, the transition region may falsely indicate color if one of the color component value lags the other slightly. For example, a white pixel with RGB value (255,255,255) in a 24-bit environment might yield (255,80,255), indicating some chrominance value when converted to YCrCb color space. To minimize this effect, transition pixels can be avoided and substituted with subsequent stable pixels.

Referring now to FIG. 5, a block diagram depicting the states within state machine 45 responsible for updating the histogram (or other) values in the RAM table is shown. These states include detecting an incoming pixel (block 50), generating a table index value (block 51), reading the current table value (block 52), incrementing (block 53), and storing the new value into the histogram table (block 54).

Still referring to FIG. 5, in order to achieve the desired function of acquiring image characteristics while utilizing a RAM of reasonable size for the histogram table, sub-sampling is performed on a pixel and line basis. For example, when detecting an incoming pixel (block 50), a sub-sampling rate of 1 active line sample for every 32 lines and 1 pixel for every 32 therein results in a sampling of about 1/10th of 1% of the pixels, or 0.1%, yet the dispersion of the collection provides an adequate sample capable of predicting whether a document is black and white only or color. With such a sub-sampling rate, an entire 600 dpi, letter-sized image can be evaluated without any particular color count exceeding a maximum count of 65535 that would be available given a ram with a width of 16 bits. When higher sub-sampling rates are desired, the table may be interrogated by the host processor part way through the page, cleared, and re-enabled for another band of the image.

Still referring to FIG. 5, the histogram represents an occurrence count in a 3-dimensional color space of YCrCb for each possible color index. This occurrence count updated by incrementing the count if a maximum value has not been reached (block 53), and storing a new value (block 54). A black and white document would yield histographic results indicating a variety of Y intensity values, but most with negligible Cr and Cb components. The most predominant Y value would most likely indicate the background intensity of the document, and the most common dark/black (low Y) values might indicate the intensity of the text regions. This information is useful for binarization, and a gamma stage could be implemented to perform contrast enhancement. In this manner, a document with dark gray text on an off-white (yellowed) background could be reproduced perfectly with a white background and black text, if desired. In addition, the number of sharp intensity or color transitions per line or per region of the input image may be detected and used to establish the presence color text.

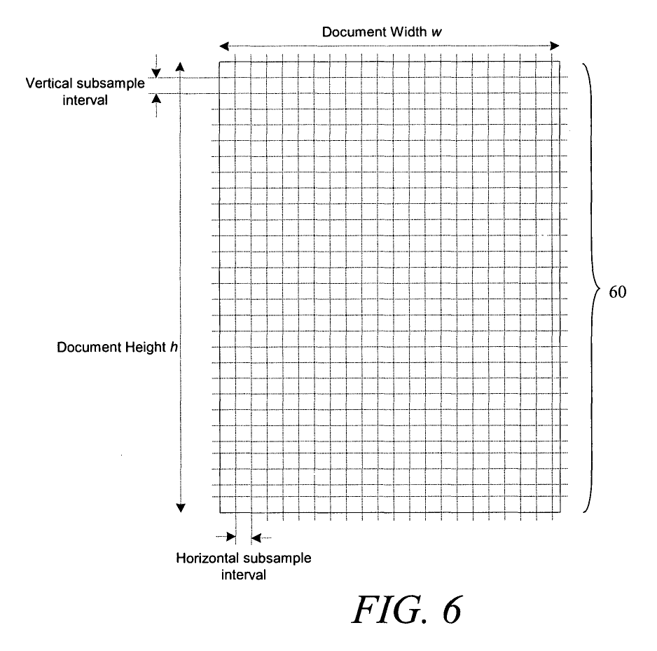

With reference to FIG. 6, a graphical depiction of a sub-sample grid for the present invention is shown. Horizontal sub-samples are taken along the width W of sub-sample grid 60. Vertical sub-samples are similarly taken along the height H of sub-sample grid 60.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A method for determining characteristics of an input image, the method comprising the steps of:
receiving a single pixel stream of the input image;
sub-sampling data from the single pixel stream at programmable intervals; and
creating a histogram with characteristics of the input image based on the sub-sampled data.

2. The method according to claim 1 wherein the step of receiving the single pixel stream further comprises the steps of:
scanning the input image; and
pre-analyzing the input image to compensate for inadequacies associated with scanning.

3. The method according to claim 1 wherein the single pixel stream is sub-sampled on a line basis.

4. The method according to claim 1 wherein the single pixel stream is sub-sampled on a pixel basis.

5. The method according to claim 1 wherein the histogram maintains data to determine whether the input image is color or black and white, photo or text, low in contrast or high in contrast, and dark or light.

6. The method according to claim 1 further comprising the step of determining a maximum and minimum value, a first and last value, and an average value for each characteristic of the input image.

7. The method according to claim 1 further comprising the step of substituting transition pixels with stable pixels to compensate for sampling effects.

8. The method according to claim 1 wherein single pixel stream is truncated to a minimal number of bits to reduce a depth of the histogram.

9. The method according to claim 1 wherein determining characteristics of the input image facilitates subsequent imaging processing functions.

10. An apparatus for determining characteristics of an input image, the apparatus comprising:
receiving means for receiving a single pixel stream of the input image;
sub-sampling means for sub-sampling data from the single pixel stream at programmable intervals; and
a histogram that maintains characteristics of the input image based on the sub-sampled data;

11. The apparatus according to claim 10 wherein the receiving means stream further comprises:
a scanner for scanning the input image; and
pre-analysis means to compensate for inadequacies associated with scanning.

12. The apparatus according to claim 10 wherein the single pixel stream is sub-sampled on a line basis.

13. The apparatus according to claim 10 wherein the single pixel stream is sub-sampled on a pixel basis.

14. The apparatus according to claim 10 wherein the histogram maintains data to determine whether the input image is color or black and white, photo or text, low in contrast or high in contrast, and dark or light.

15. The apparatus according to claim 10 further comprising a means for determining a maximum and minimum value, a first and last value, and an average value for each characteristic of the input image.

16. The apparatus according to claim 10 further comprising a means for substituting transition pixels with stable pixels to compensate for sampling effects.

17. The apparatus according to claim 10 wherein single pixel stream is truncated to a minimal number of bits to reduce a depth of the histogram.

18. The apparatus according to claim 10 wherein determining characteristics of the input image facilitates subsequent imaging processing functions.
